(19) United States
(12) Patent Application Publication
(10) Pub. No.: US 2015/0009682 A1
(43) Pub. Date: Jan. 8, 2015

(54) LED LIGHT

(71) Applicant: Christian James Clough, Ames, IA (US)

(72) Inventor: Christian James Clough, Ames, IA (US)

(21) Appl. No.: 13/934,689

(22) Filed: Jul. 3, 2013

(51) Int. Cl. F21V 13/02

(52) U.S. Cl. CPC F21V 13/02
USPC 362/311.02

(57) ABSTRACT

The present invention is directed towards a light assembly, such as an LED light assembly. A cluster of light beams positioned on a substrate and connected to a power source. The light beams produced by the cluster of LED lights are captured in a mixing chamber and passed through an optical diffusing member. The plurality of light beams will be combined by the combination of the mixing chamber and optical diffuser such that a more uniformed beam is produced. The uniformed beam is then passed through a lens member to be oriented or directed towards the intended location or use of the light beam produced by the light assembly.

### FIELD OF THE INVENTION

The present invention relates generally to lighting systems. More particularly, but not exclusively, the invention relates to an LED light assembly that reduces shadowing effect caused by a cluster of lights to increase physiological benefits of the light.

### BACKGROUND OF THE INVENTION

Light emitting diode (LED) lights, and more particularly, groups of LED lights, are currently used to illuminate a variety of areas. The lights are placed in clusters to provide a specifically oriented ray of light, as with a flashlight, or they are added to strips for illuminating a larger, more generalized area. Although a number of LEDs are needed to produce enough light to illuminate a desired area, LEDs do not require as much energy as standard lighting, and are more efficient than incandescent bulbs. In addition, LEDs have a much longer lifetime than either fluorescent or incandescent bulbs. The lifetime is generally three to four times longer than fluorescent tubes, and twenty-five to thirty times longer than incandescent bulbs. Additionally, the on/off time and the efficiency of LEDs are better than fluorescent or incandescent lights.

However, the cluster of LED lights used to create the beams of light can produce unwanted shadow effects. As the lights are positioned closely together, but not on top of one another, the light beams created by each individual light in the cluster will be overlapping to adjacent lights. The non-uniform beam can be deficient with regards to its intended purpose, which may be to provide physiological benefits to an organism to which the beam is intended to be directed.

Therefore, there is a need in the art for an LED light assembly that utilizes a cluster of LED lights to create a beam that provides for reduced shadow effects caused by the overlapping beams of the cluster. There is also a need in the art for an improved LED light assembly for creating an oriented beam of light to provide physiological benefits.

### SUMMARY OF THE INVENTION

It is therefore a primary object, feature, and/or advantage of the present invention to improve on or overcome the deficiencies in the art.

It is another object, feature, and/or advantage of the present invention to provide a light assembly that produces a beam of light to provide physiological benefits to organisms.

It is yet another object, feature, and/or advantage of the present invention to provide an LED light assembly that reduces the shadow effect caused by the use of a cluster of LED lights positioned together.

It is still another object, feature, and/or advantage of the present invention to provide an LED light assembly that combines beams of light from individual lights into a single beam with a direction and/or orientation.

It is a further object, feature, and/or advantage of the present invention to provide a light assembly that can be quickly and easily hooked up to a power source.

It is yet a further object, feature, and/or advantage of the present invention to provide an LED light assembly that can incorporate multiple lenses.

These and/or other objects, features, and advantages of the present invention will be apparent to those skilled in the art. The present invention is not to be limited to or by these objects, features and advantages, and no single embodiment need exhibit every object, feature, and/or advantage.

According to an aspect of the invention, an LED light assembly is provided. The light assembly includes, at least in part, two or more LED lights, a mixing chamber positioned adjacent the two or more LED lights, a diffuser positioned adjacent the mixing chamber, and a lens positioned adjacent the diffuser and configured to direct a beam of light from the two or more LED lights.

The light beams from the two or more LED lights are combined in the mixing chamber. The combined beams are then passed through the diffuser to provide a single, or near single, beam of light. The light is then directed and/or oriented by the shape and configuration of the lens or portions of the lens to direct the combined light toward its intended location. The combining of the light beams in the mixing chamber and by the diffuser will aid in reducing the shadow effect caused by overlapping portions of the beams created by the individual light sources.

According to another aspect of the invention, an LED light assembly for orienting a beam created by a cluster of lights is provided. The assembly includes a cluster of LED lights, an optical diffuser positioned away from the cluster of LED lights, and a lens positioned adjacent the optical diffuser and configured to orient a beam of light from the cluster of LED lights.

According to yet another aspect of the invention, an LED light assembly for orienting beams of light created by a tightly packed cluster of LED lights is provided. The assembly includes a mixing chamber positioned adjacent the cluster of LED lights and an optical diffuser positioned adjacent the mixing chamber. The mixing chamber is configured to direct a plurality of beams from the cluster of LED lights to the diffuser. A lens is positioned adjacent the mixing chamber and optical diffuser and configured to direct or orient light from the optical diffuser in a desired manner.

### BRIEF DESCRIPTION OF THE DRAWINGS

FIG. 1 is a perspective view of an LED light assembly according to an embodiment of the present invention.

FIG. 2 is an exploded view of the assembly of FIG. 1.

FIG. 3 is a side sectional view of the assembly of FIG. 1.

FIG. 4 is a top view of a substrate with LED lights according to an aspect of the present invention.

FIG. 5 is a side view of a mixing chamber according to an aspect of the invention.

FIG. 6 is a top view of the mixing chamber of FIG. 5.

FIG. 7 is a perspective view of an optical diffuser according to an aspect of the present invention.

FIG. 8 is a side view of a lens according to an aspect of the invention.

FIG. 9 is a top view of the lens of FIG. 8.

### DETAILED DESCRIPTION OF THE PREFERRED EMBODIMENTS

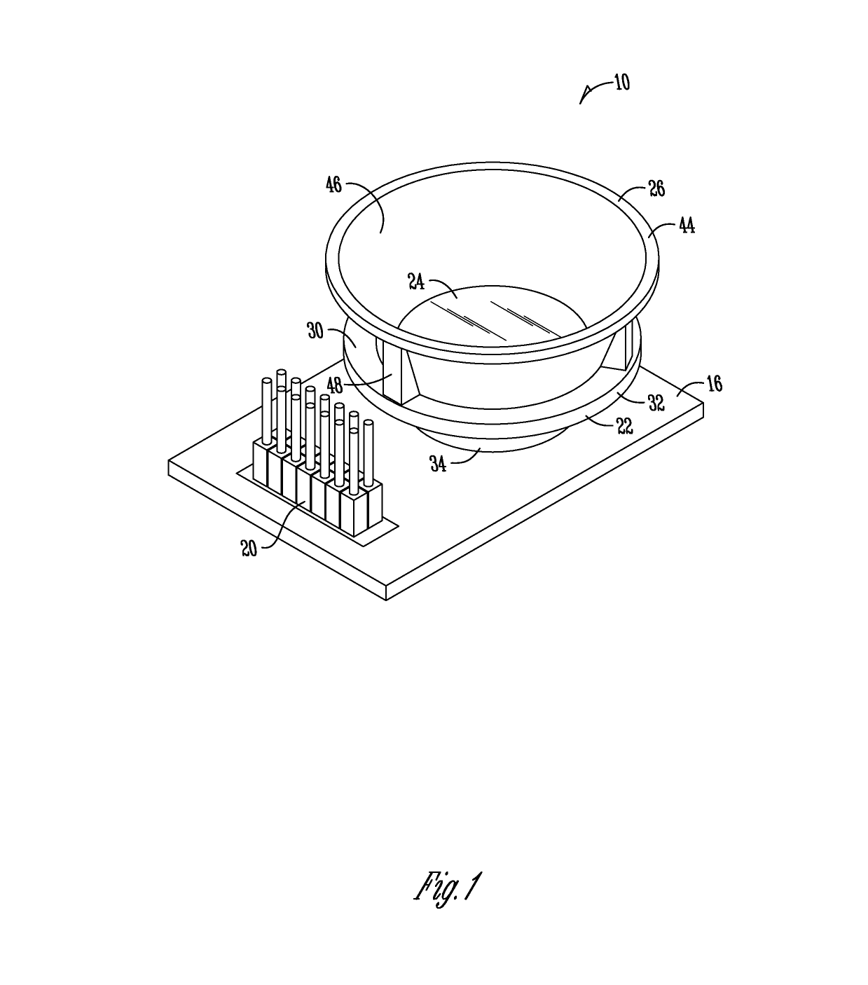

FIG. 1 is a perspective view of an LED light assembly 10 according to an embodiment of the invention. The light assembly 10 as shown and described can be used with aquariums or other environments, including both faux environments and real environments, such as an outside area. The assembly 10 according to the embodiments of the present invention provides numerous benefits over previous light assemblies. For example, as will be understood, the light assembly 10 includes a cluster of LED lights 12 that will provide a light source for a location in the aquarium or other environment that captures the light emitted from substantially all of the lights to produce a uniform beam of light. The configurations of the embodiments of the invention will reduce a shadowing effect caused by the use of multiple LED lights 14 being oriented towards a certain direction or end point or end point area. Thus, the invention provides for an assembly that will have a more uniform light beam 54 obtained from individual light beams 52 of the cluster or plurality of LED lights. This single and/or uniform light beam 54 will provide physiological benefits due to the direct beam light beam produced by the light assembly 10. The light shines on an area of the aquarium or other environment to produce benefits due to the more direct light beam obtained from the plurality of LED lights 14.

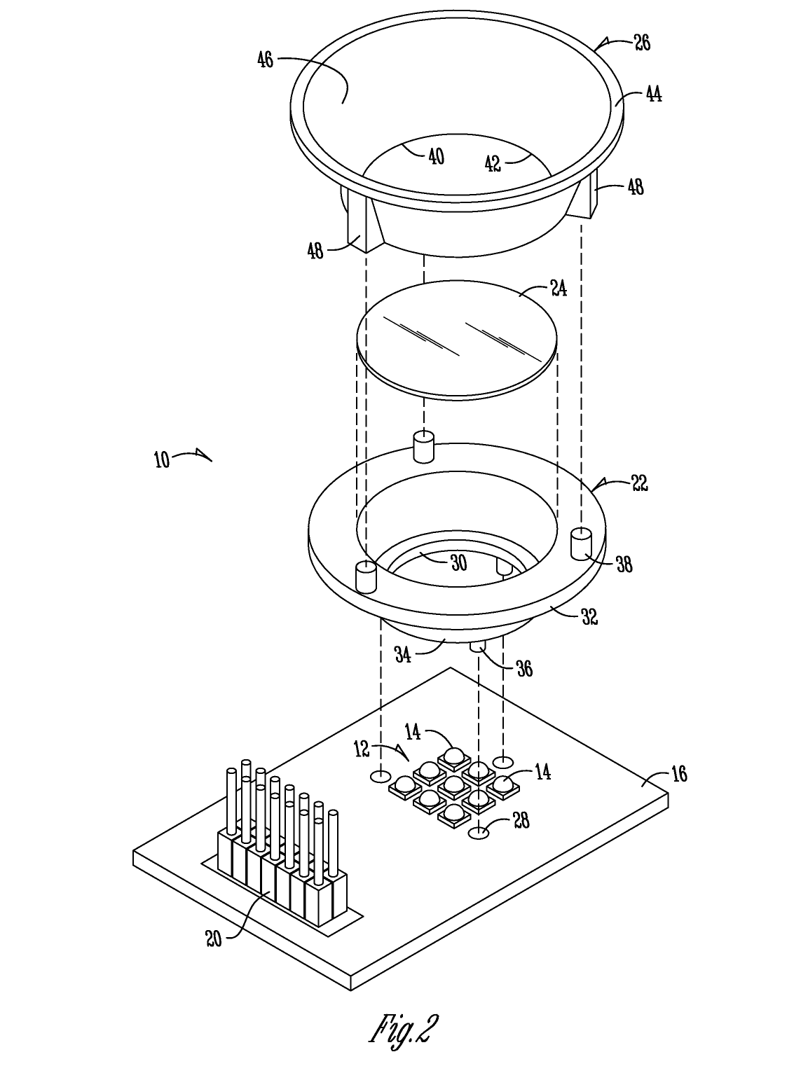

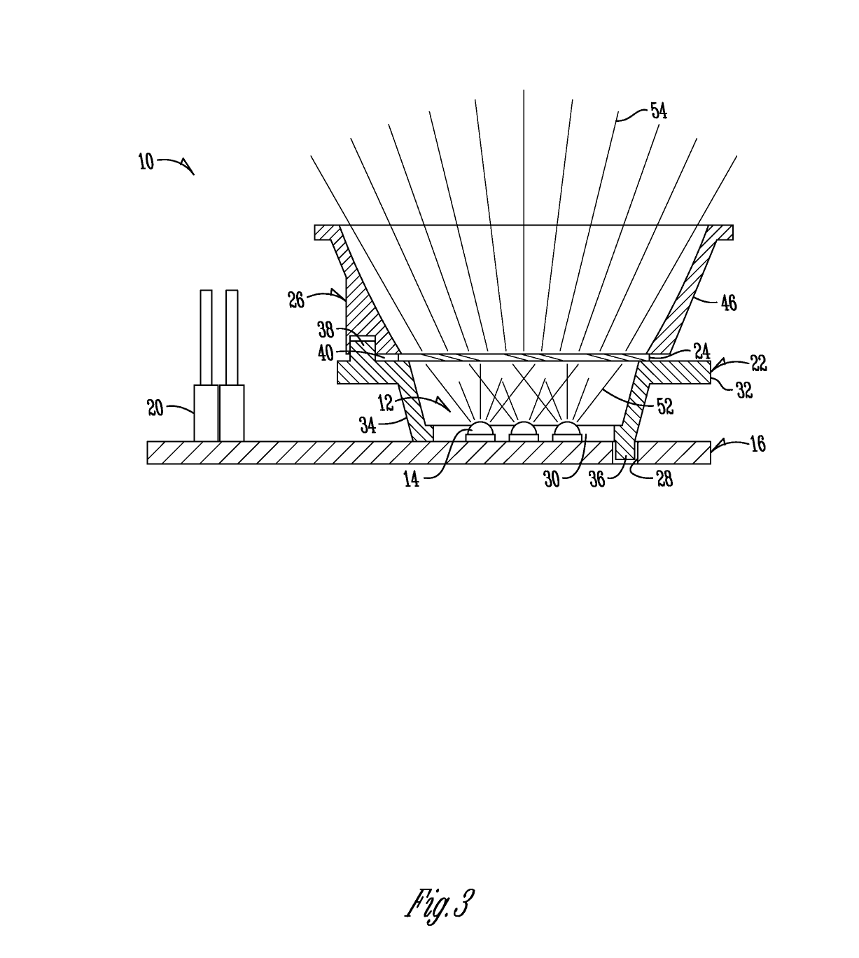

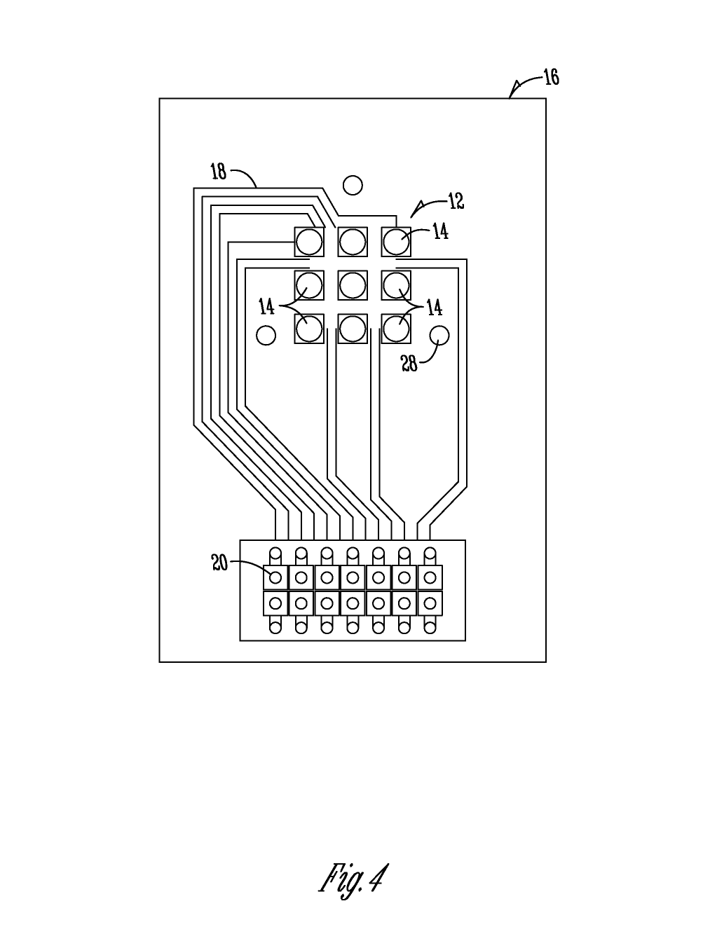

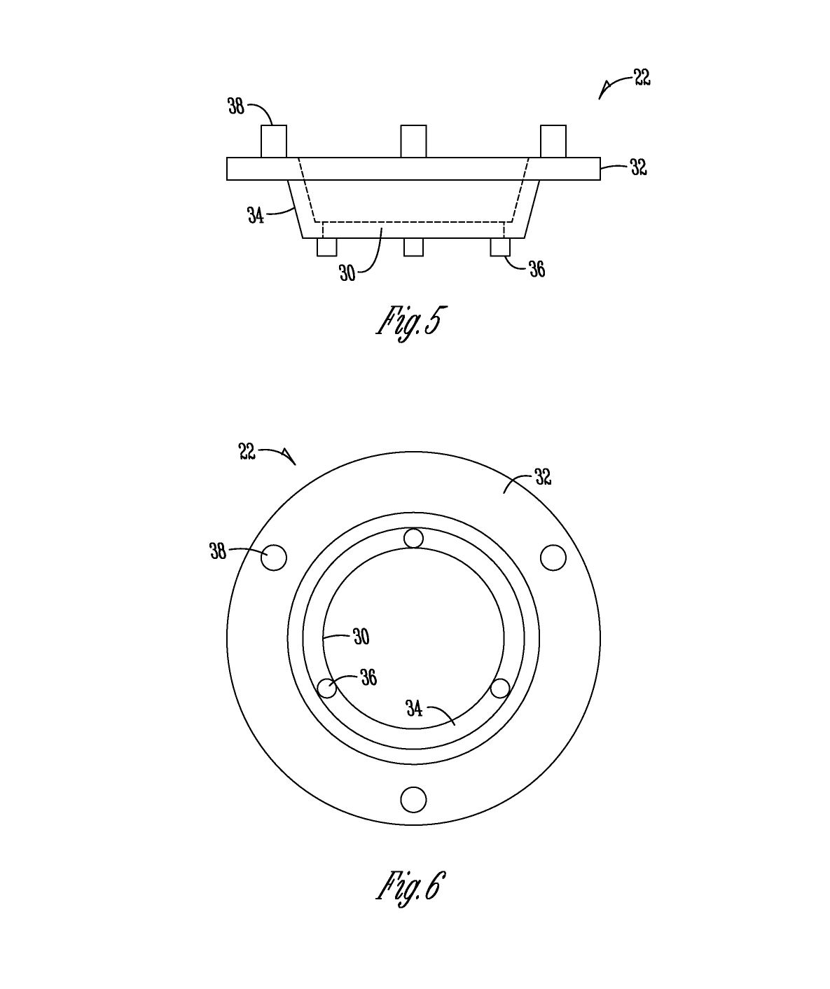

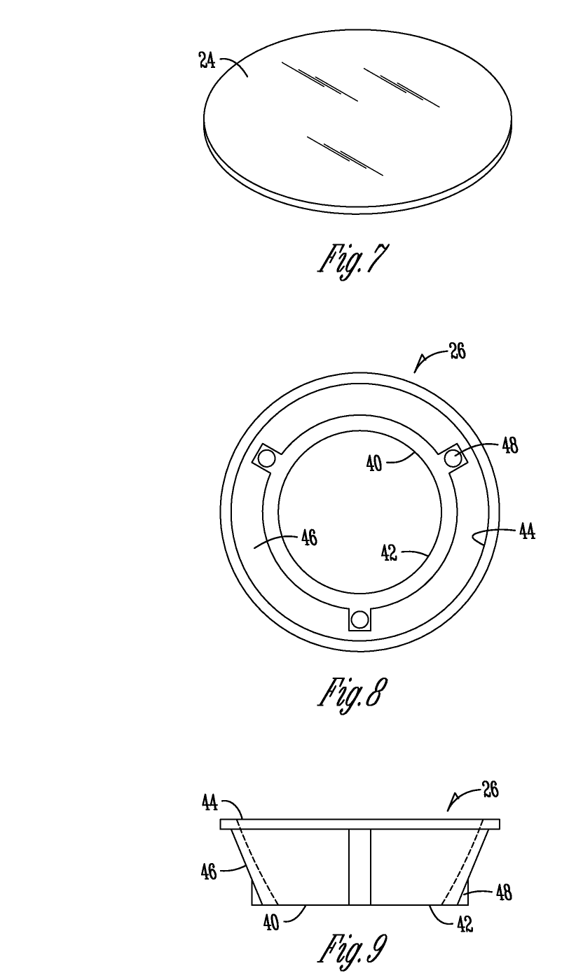

FIGS. 1 and 2 show the main components of the light assembly 10 according to an exemplary embodiment of the present invention. It is to be understood that the embodiments shown in figures are shown for exemplary purposes, and are not to be an exhaustive or complete list. As mentioned, the light assembly 10 includes a cluster 12 of LED lights 14. The lights 14 may be positioned and operatively or electrically coupled to a substrate 16. The LED lights 14 forming at the cluster 12 include generally any number and configuration of lights such that the present invention contemplates that the number of lights may be varied according to an intended use for the light assembly 10. In addition, the cluster 12 of LED lights 14 may comprise different intensities, colors, and/or other light characteristics. The substrate may comprise generally any material capable of allowing the lights to be attached thereto such as an aluminum or fiberglass-resin based board/substrate. Also shown in FIGS. 1, 2, and 4 is a power source or power source connection member 20 positioned at or on the substrate 16 such that the power source connector 20 can be attached to power source (not shown) to provide electricity to the assembly 10 such that it powers the LED lights 14. Thus, the LED lights 14 may be electrically coupled to the power source connector 20, such as by circuitry 18 in or on the substrate 16. Furthermore, the present invention contemplates that each substrate 16 includes its own power source (not shown) such that the assembly 10 will comprise a self-powered assembly without the need to connect it to a separate power source.

Shown in the figures adjacent the cluster 12 of LED lights 14 and attached to the substrate 16 is a mixing chamber 22. The mixing chamber 22 comprises a molded or otherwise formed plastic or other rigid material for capturing the LED light beams 52 and corralling them or controlling the orientation of said light beams. The mixing chamber 22 includes an aperture 30 therethrough such that the mixing chamber is a generally hollow member. Furthermore, the mixing chamber may include a flange portion 32 and a cylinder portion 34 extending generally from the flange portion. A first set of protrusions 36 extend from a portion of the mixing chamber 22 and can be inserted into substrate apertures 28 in the substrate 16. Thus, the protrusions and apertures will align such that the mixing chamber can be attached to the substrate 16 via the protrusions 36 and apertures 28. The mixing chamber 22 can be held at the substrate 16 using adhesives or other temporary or permanent attaching means as well. Furthermore, the mixing chamber 22 may include a second set of protrusions 38, which can aid in attaching the mixing chamber 22 to a lens 26.

As mentioned, the mixing chamber 22 is positioned generally adjacent the cluster 12 of LED lights 14 such that the light beams 52 of the LED lights 14 are corralled or mixed within the mixing chamber 22. An example of this is shown in FIG. 3. Therefore, the mixing chamber may comprise a generally opaque material such that the beams 52 from the LED lights 14 substantially do not pass through the mixing chamber 22 before the intended exit or orientation of the beams.

Positioned generally adjacent the mixing chamber 22 and resting on the flange portion 32 of the mixing chamber 22 is an optical diffuser 24. As shown through the figures, the optical diffuser 24 may be a cylinder or circular shaped member. The optical diffuser 24 comprises a material that diffuses the beams 52 of the LED lights 14 prior to entering the lens 26 of the light assembly 10. The diffuser 24 may receive the beams 52 of the LED lights 12 and can manipulate said beams per the characteristics of the optical diffuser 24. For example, as is known, optical diffusers generally receive light and change the configuration of the light or light beams as the light passes through the diffuser. Thus, according to an embodiment of the invention, the diffuser 24 may receive the plurality of beams 52 from the LED lights 14 and diffuse the beams into a more singular or uniform beam passing out of the diffuser and into the lens 26. It is further contemplated that the diffuser 24 may create a specifically shaped or configured beam as may be desired for the end use or desired use of the beams of the light assembly 10. Furthermore, while the optical diffuser 24 shown in the figures is circular or cylindrical shaped, it is to be understood that the present invention contemplates that generally any configuration and/or shape of the diffuser may be included. Furthermore, it is contemplated that the optical diffuser need not be positioned between the lens 26 and the mixing chamber 22, and may be positioned generally either within or at either of the mixing chamber 22 and/or lens 26. The positioned configuration of the optical diffuser 24 shown in the figures is for exemplary purposes only.

As mentioned, a lens 26 is positioned generally adjacent the mixing chamber 22 and the optical diffuser 24. The lens 26, for purposes of the present invention, is understood to be a member used to orient and/or manipulate the direction of the combined light beam 54 formed from the cluster 12 of the LED lights 14 of the assembly 10. The lens 26 may be a single unit, as shown in the figures, or may be a multi-component lens with multiple parts forming a straight, curved, or otherwise bent (elbowed) configuration to orient the light passing therethrough. As shown in FIG. 3, the beams 52 of the LED lights 14 have mixed in the mixing chamber 22. As mentioned, these beams 54 may comprise different intensities, colors, and the like. As the beams pass through the diffuser 24, they are combined or otherwise manipulated to form a more uniformed or desired beam 54. This beam 54 can then be manipulated via the lens 26 to direct the beam to an area or otherwise desired end point or use, such as towards flora and/or fauna within an aquarium or other environment. Therefore, the lens 26 may take many different shapes and forms according to the different uses for the intended output of the light assembly 10.

As shown in the figures, the lens 26 according to an exemplary embodiment is a generally conical shaped member. The lens 26 is a hollow member having an aperture 40 extending from an entrance 42 for the light beams to an exit 44 of the light beams. As shown in the figures, the entrance 42 of the lens 26 is generally narrower than the exit 44. This particular shape will allow the beams 54 to expand as they pass through the lens 26. However, this is not to be understood to be the only configuration of the lens. A lens body 46 extends between the entrance and exit 42, 44 of the lens 26. The body is shaped to orient the light beam(s) 54 from the optical diffuser 24 to or towards the intended use or location for the light beam 54. In addition, the lens 26 may comprise a molded material, such as plastic. The plastic material may be generally opaque such that the light beams 54 do not substantially pass through the lens and instead, are directed towards the intended use and/or location for the light beam 54. The lens 26 also includes connections 48, which may include apertures therein for receiving the protrusions 38 of the mixing chamber 22, according to an exemplary embodiment as shown in the figures. However, as have been mentioned, the lens may be attached to the mixing chamber in any manner. For example, the lens 26 may include protrusions that extend to into apertures in the mixing chamber, or the lens and mixing chamber may be simply glued or otherwise attached to one another to prevent or mitigate the light beams passing or escaping from the assembly prior to the lens exit 44. Furthermore, the lens 26 may be attached to the mixing chamber 22 via an adhesive or other sealing means. In still further embodiments, it is contemplated that the mixing chamber and the lens form a single, unitary component, with the optical diffuser positioned therein.

Therefore, the light assembly 10 operates in the following general manner. As shown throughout the figures, a cluster 12 of LED lights 14 is positioned on the substrate 16 and electrically connected to a power source or power source connector 20 via circuitry 18 in and/or on the substrate 16. The substrate and connection or power source provide electricity to operate or power the LED lights 14. The LED lights 14 include either the same or different intensities, colors, sizes, etc. The light beams emitted by the LED lights 14 are captured and combined in the mixing chamber 22 adjacent the LED lights 14. The mixing chamber corrals the beams such that they are passed through an optical diffuser 24. The optical diffuser 24 comprises a diffusing material configured to receive a plurality of light beams and to manipulate the beams into a desired output, such as a uniform beam of desired configuration. Thus, as shown in FIG. 3, the overlapping light beams 52 may be combined into a more uniform or single light beam 54.

The beams 54 exiting the optical diffuser 24 are then manipulated and/or oriented by a lens member 26 to direct or orient the light beams 54 to an end use location or desired use. Thus, the light assembly 10 of the present invention provides the ability to combine a plurality of light, including different intensities, colors, and other characteristics to provide a single, uniform, or otherwise manipulated output light that may provide benefits, such as physiological benefits to an organism, such as flora and/or fauna, in an aquarium or other environment.

An LED light assembly has been shown and described. As mentioned, the light assembly 10 can be used in an aquarium or other environment. This includes using the light assembly in an outdoor environment or in a room or building not included in an aquarium. As is understood, the benefits from the light assembly 10 providing a generally uniform or otherwise configured light beam from the plurality of individual lights is hugely beneficial and may provide many advantages over the prior art. At least one of these advantages is reduction of a shadowing effect caused by the overlapping beams of the individual lights. The invention includes the ability to provide a single uniform light beam from the plurality of lights such as the reduction of the shadowing effect is accomplished.

In addition, numerous various, adjustments, substitutions, and the like may be incorporated into the present invention and are intended to be considered a part of the present invention. It should be understood that additional changes and modifications to the embodiment shown and described herein will be apparent to those skilled in the art. Such changes and modifications may be made without departing from the spirit and scope of the invention, and without diminishing its advantages. It is intended, therefore, that such changes and modifications be covered by the embodiments of the invention.

What is claimed is:

1. An LED light assembly, comprising:
two or more LED lights;
a mixing chamber positioned adjacent the two or more LED lights;
a diffuser positioned adjacent the mixing chamber; and
a lens positioned adjacent the diffuser and configured to direct a beam of light from the two or more LED lights.

2. The LED light assembly of claim 1 wherein the two or more LED lights are positioned on a substrate.

3. The LED light assembly of claim 2 wherein the substrate comprises circuitry.

4. The LED light assembly of claim 3 wherein the substrate further comprises a power connection for connecting the assembly to a power source to provide electricity to power the two or more LED lights.

5. The LED light assembly of claim 4 wherein the two or more LED lights are electrically coupled to the power source.

6. The LED light assembly of claim 1 wherein the lens is conical-shaped.

7. The LED light assembly of claim 1 wherein the diffuser comprises a substantially flat sheet of material positioned at least partially between the mixing chamber and the lens.

8. The LED light assembly of claim 1 wherein the two or more LED lights comprise different colors.

9. The LED light assembly of claim 1 wherein the two or more LED lights extend at least partially into the mixing chamber.

10. An LED light assembly for orienting a beam created by a cluster of lights, comprising:
a cluster of LED lights;
an optical diffuser positioned away from the cluster of LED lights; and
a lens positioned adjacent the optical diffuser and configured to orient a beam of light from the cluster of LED lights.

11. The LED light assembly of claim 10 wherein the cluster of LED lights are positioned on a substrate.

12. The LED light assembly of claim 11 further comprising a mixing chamber positioned between the substrate and the diffuser, wherein the mixing chamber at least partially surrounds the cluster of LED lights.

13. The LED light assembly of claim 12 wherein the mixing chamber is attached to the substrate and the lens is attached to the mixing chamber.

14. The LED light assembly of claim 13 wherein the diffuser is positioned in line with apertures in the mixing chamber and the lens such that light from the cluster of LED lights passes through the diffuser.

15. The LED light assembly of claim 10 wherein the lens comprises a molded, single component lens.

16. The LED light assembly of claim 10 wherein the lens comprises a multi-component lens that is adjustable to vary the orientation of the beam.

17. The LED light assembly of claim 10 further comprising a power source electrically coupled to the cluster of LED lights.

18. An LED light assembly for orienting beams of light created by a tightly packed cluster of LED lights, comprising:
a mixing chamber positioned adjacent the cluster of LED lights;
an optical diffuser positioned adjacent the mixing chamber;
wherein the mixing chamber is configured to combine a plurality of beams from the cluster of LED lights to direct them to the diffuser; and
a lens positioned adjacent the mixing chamber and optical diffuser and configured to direct or orient light from the optical diffuser in a desired manner.

19. The LED light assembly of claim 18 wherein the lens is conical shaped.

20. The LED light assembly of claim 18 wherein the mixing chamber and lens include apertures therethrough, and the optical diffuser positioned substantially in line with the apertures.
